(19) United States
(12) Patent Application Publication
(10) Pub. No.: US 2015/0332038 A1
(43) Pub. Date: Nov. 19, 2015

(54) SECURE ENTRY OF SECRETS

(71) Applicant: Adriana Lyons, Henderson, NV (US)

(72) Inventor: Rodney Russell Ramsden, Mississauga (CA)

(73) Assignee: Adriana Lyons, Henderson, NV (US)

(21) Appl. No.: 14/714,291

(22) Filed: May 16, 2015

Related U.S. Application Data
(60) Provisional application No. 61/994,851, filed on May 17, 2014.

(51) Int. Cl. G06F 21/36; G06F 21/32; G06Q 20/20

(52) U.S. Cl. CPC G06F 21/36; G06Q 20/206; G06F 21/32

(57) ABSTRACT

Disclosed is a method for enabling the input of a secret at an electronic device. The method includes establishing a plurality of primary identifiers and a plurality of secondary identifiers; associating each secondary identifier with a corresponding primary identifier by use of a mapping function; on a display configured such that it is only viewable by a single user displaying the plurality of primary identifiers and the plurality of secondary identifiers, with each secondary identifier being associated with a corresponding primary identifier; receiving one or more inputs from the user indicating a secondary identifier, translating each input secondary identifier using the mapping function to its corresponding primary identifier to generate one or more primary identifiers and using the generated primary identifiers as an input to an authentication function where the authentication function allows access to private data or functionality associated with an electronic device.

### CROSS-REFERENCE TO RELATED APPLICATIONS

The instant application claims priority to U.S. Provisional Patent Application Ser. No. 61/994,851, filed May 17, 2014 which is hereby expressly incorporated herein by reference in its entirety.

### TECHNICAL FIELD

The present disclosure relates generally to systems and methods for the secure entry of secrets at a computing device.

### BACKGROUND OF THE INVENTION

A computing device can enter a locked state when it is not used for a while or when a user provides input that causes the computing device to enter the locked state. For example, a computing device may lock if a user presses a “lock” button, or if a determined amount of time passes since the user has provided any user input. While in the locked state, features of a computing device may be restricted. Certain limited features may be available, such as a display of the current time, and an ability to dial an emergency telephone number, while most features may be unavailable, such as access to contact data on the device and ability to interact with applications the user has loaded on the device. As such, a user may not be able to access the restricted features unless the user enters an unlocking pattern that causes the device to enter an unlocked state. A device that locks can prevent unauthorized users from accessing the restricted features. Further a device that locks can prevent a user from unintentionally providing user input and launching computing device actions (e.g., calling a person or visiting a website).

There are also many examples of existing devices or applications running on existing devices that require the entry of a PIN, password or other secrets. These include access control systems, security systems such as alarms, ATMs, Point of Sale systems using EMV (known as ‘chip and PIN’) or access to a desktop PC running ‘Windows’ or ‘Mac OS’. This is not meant to be an exhaustive list; it will be readily apparent from this disclosure that all possible such implementations are contemplated without deviating from the spirit of this invention.

U.S. Pat. No. 8,046,721, assigned to Apple Inc., describes an unlocking method using a pattern, but such a method does not prevent unauthorized access. U.S. Pat. No. 8,504,842, assigned to Google Inc., describes an improvement to lock screens that uses gestures on the touch screen as an unlocking method, to prevent unauthorized access. This method, along with other techniques such as entering a PIN (Personal Identification Number) by a physical or touchscreen keyboard, provides some degree of security but has the disadvantage that a PIN or gesture may be captured by a criminal by either ‘shoulder surfing’ (In computer security, shoulder surfing refers to using direct observation techniques, such as looking over someone's shoulder, to get information. It is commonly used to obtain passwords, PINs, security codes, and similar data) or in the case of ATMs by the use of a hidden camera installed proximate to the PIN keypad which captures a video or photographic recording of the customer's fingers as they operate the keypad whilst copying or ‘skimming’ the magnetic stripe or smartcard chip on the customer's credit or debit card as it is inserted into the ATM.

US Patent Application 20130282502, assigned to Google Inc., describes a system for making payments at a Point Of Sale (POS) terminal using a mobile phone along with Near Field Communication (NFC) technology. This requires using an unlocking method at the mobile phone which has the potential to be eavesdropped.

U.S. Pat. No. 8,632,000, assigned to Paydiant, has one method of using mobile devices to access an ATM. However, this method does not solve the problem of snooping the user of the mobile device. If a user is seen entering their PIN at their mobile phone, then a theft of the mobile phone will gain access to the ATM.

U.S. Design Pat. D659741 shows a particular model of a wearable computer, currently marketed by Google Inc., as ‘Glass’. Other examples of wearable computers are those made by Microsoft, marketed as ‘Hololens’ or Oculus, marketed as ‘Rift’. Wearable computers provide many new functions for users, such as the ability to record interactions with other persons, but suffer even more than mobile devices with the difficulty of providing security for the private data of said users, due to the lack of a conventional keyboard, touchscreen or mouse for input of passwords, PINs or other secrets. US Patent Application 20130044042, also assigned to Google Inc., provides some information about the functionality present in a wearable computer.

There therefore exists a need to provide better methods for securing the privacy of data stored or accessed from mobile, wearable or other devices.

### SUMMARY OF THE INVENTION

An embodiment of the present disclosure relates to an electronic device with associated display configured such that said device can display information that is only decipherable by a single user at one time. Such information may be used by said user to translate a secret such as a password or PIN code into a value or values that may be freely used to authenticate the user without concern that another party may also obtain the secret. Once authenticated, the user may access private data, accounts or other functionality present in the electronic device.

Another embodiment of the present disclosure relates to an electronic device with associated display configured such that said device can display information that is only decipherable by a single user at one time. Such information may be used by said user to translate a secret such as a password or PIN code into a value or values that may be freely used to authenticate the user without concern that another party may also obtain the secret. Once authenticated, the user may access private data, accounts or other functionality present on another electronic device, server or system.

Another embodiment of the present disclosure relates to an electronic device with associated display configured such that said device can display information that is only decipherable by a single user at one time. Such information may be used by said user to translate a secret such as a password or PIN code into a value or values that may be entered into a second electronic device to authenticate the user without concern that another party may also obtain the secret. Once authenticated, the user may access private data, accounts or other functionality present in either the first or second electronic device.

Another embodiment of the present disclosure relates to an electronic device with associated display configured such that said device can display information that is only decipherable by a single user at one time. Such information may be used by said user to translate a secret such as a password or PIN code into a value or values that may be entered into a second electronic device to authenticate the user without concern that another party may also obtain the secret. Once authenticated, the user may access private data, accounts or other functionality present on a third device, server or system.

### BRIEF DESCRIPTION OF THE DRAWINGS

FIG. 1A is an example arrangement on a private display of a PIN entry with associated letters

FIG. 1B is an example arrangement on a private display of a PIN entry with associated letters and four digits already determined and displayed to the user

FIG. 1C is an example arrangement on a private display of a PIN entry with associated letters and four letters already recognized and displayed to the user

FIG. 2 is an example arrangement on a private display of a PIN entry with associated words

FIG. 3 is an example of a wearable computing device

FIG. 4 is an example process for securely entering a PIN to unlock a worn computing device

FIG. 5 is an example mapping of letters and words to numbers and commands during process in FIG. 4 with reference to FIG. 1A to FIG. 1C

FIG. 6 is an example of a mobile device operating a mobile wallet application

FIG. 7A is an example of a mobile device operating as part of the process in FIG. 9

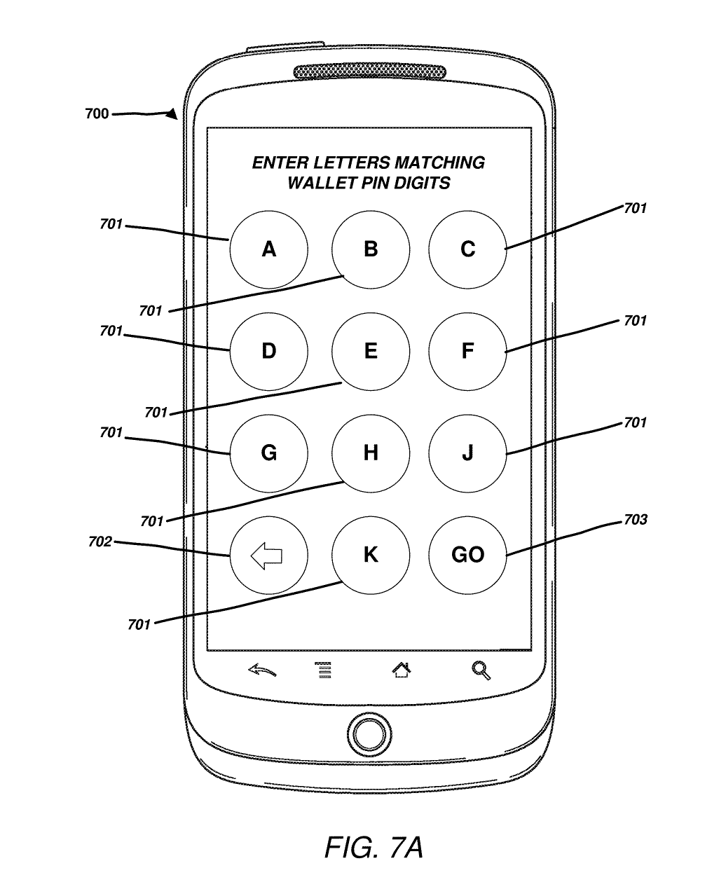

FIG. 7B is an example arrangement on a private display of a PIN entry with associated letters as part of the process in FIG. 9

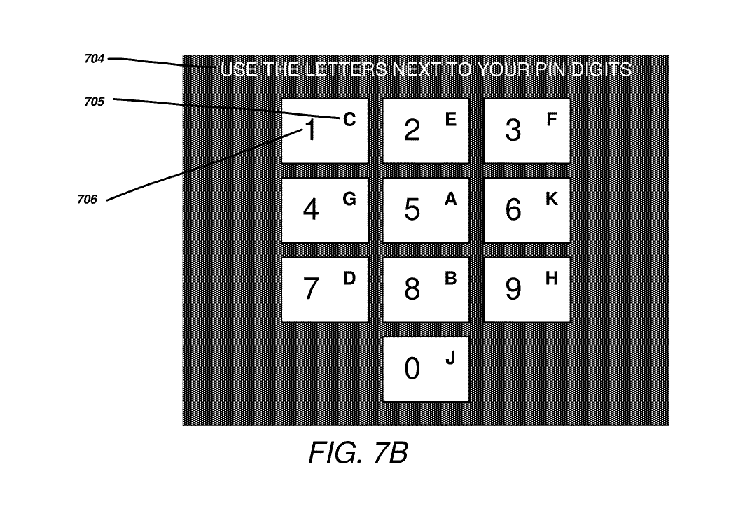

FIG. 8 is an example process for securely entering a PIN at a secondary device to unlock a primary device

FIG. 9 is an example process for securely entering a PIN at a primary device using a secondary display device to enable the user to encrypt the PIN into a one-time string of letters

FIG. 10 is an example arrangement of a system to implement the invention to access an ATM securely

FIG. 11 is an example arrangement of a system to implement the invention to access a POS terminal securely

FIG. 12 is an example process for making a payment at a POS terminal using existing technology but removing the insecurity of openly entering a PIN

FIG. 13 is an example arrangement on a private display of password entry with associated letters, numbers and symbols

FIG. 14 is an example of a mobile device displaying a virtual keyboard

### DETAILED DESCRIPTION

Embodiments of the present disclosure are described herein with reference to the drawing figures.

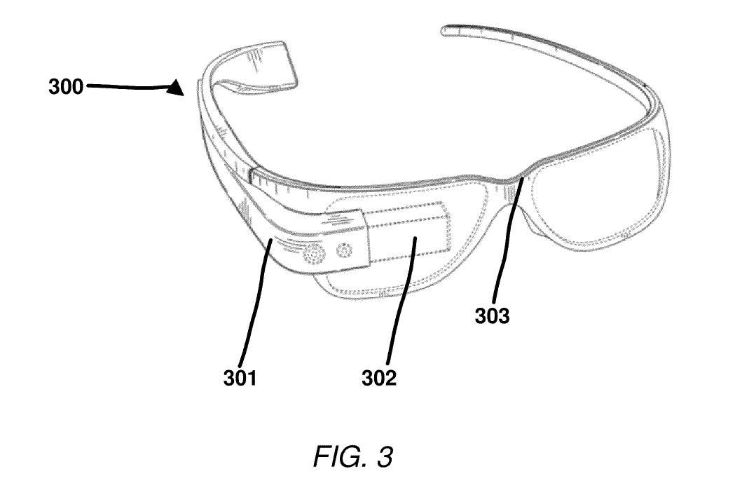

FIG. 3 shows a typical wearable computer (300), as sold by vendors such as Google (“Google Glass”). Whilst this device is head mounted (303), the system and methods described in this disclosure could also apply to other devices, both wearable and non-wearable. The device (300) has an arm (301) attached to it which includes a number of elements, hidden from view. Firstly, it has a processor with associated storage and sensors. A typical processor may be an ARM core licensed from ARM, or an x86 core licensed from Intel Inc. Programming instructions may be read from computer readable media such as flash memory, to load applications onto the device for execution. Secondly, it has network connections through either Bluetooth or WiFi radios and network stacks. Again, other network technologies such as 3G or LTE could also be used for network connectivity. Thirdly, it has a battery allowing the device to be operated without a power tether. Typically, the processor would execute instructions from the ‘Android’ operating system, though again this invention could use other operating systems such as Windows, Mac OS, iOS, Tizen, WebOS or any other applicable software. One of the peripherals and inputs built into the device shown in FIG. 3 that the first embodiment of this invention uses is a microphone. Typically the data sampled by the microphone is fed to the operating system present on the device, where it is either analyzed locally, passed to a remote ‘Cloud’ server over a network connection for analysis, or some combination of the two. This analysis takes the form of voice or speech recognition, where spoken words are translated into letters, numbers, characters or strings of text data. Such recognition technology is well known in the art, for example as described in U.S. Pat. No. 7,698,131 incorporated by reference herein, and in recent years has attained a very high standard of accuracy.

Another element (302) of the wearable computer is the display. In the example shown, the display uses LCD technology, projected onto a mirror so that it appears in front of the user's right eye. The display is very small—about 0.375 inch in both dimensions, but is so close to the user's eye that it appears as a large projected virtual display that is very easy to read for the user. From a third person perspective, looking towards the user whilst the wearable device is active, the display appears as a bright square close to the user's eye. Looking very closely at the display (which requires standing right in front of the user at a close distance) it is sometimes possible to make out the basic structure of the information being displayed (such as being able to recognize a ‘home’ screen consisting of a clock and the phrase “ok glass”), but beyond that it is not feasible for a non-user to read the display either overtly or covertly.

Under normal operation, the wearable device is inactive, conserving battery power, until the user activates it. The user may activate it by touching the touch sensor area on the arm (301), tilting their head to cause gyroscopic and other motion sensors to detect the head movement, or by pressing a button attached to the arm.

Once activated, the display on the device either initially shows a home screen or lock screen. By prior configuration, the user sets whether a lock screen is required—if not the home screen is shown, if so the lock screen is shown. The lock screen as deployed in the prior art uses a sequence of head movements or touches on the touch sensor to unlock the device and present the home screen.

A major deficiency of this prior art is that the unlocking operation of head movements and touches is insecure; visible to all persons around, even more so than a conventional PIN entry. Secondly, it is not hands-free unless the user uses a combination of only head movements which limits the number of possible unlock ‘patterns’ considerably. Another deficiency of the prior art is that unlocking is restricted to wholly unlocking all functions of the device, rather than only access to secure data.

This invention therefore overcomes these deficiencies by providing a device unlocking system that is secure and hands-free in operation. It also overcomes these deficiencies by providing an unlocking system that is quick and easy to use, thus allowing a user to selectively lock only some applications or functions of the worn device and allow others to be used by anybody wearing the device.

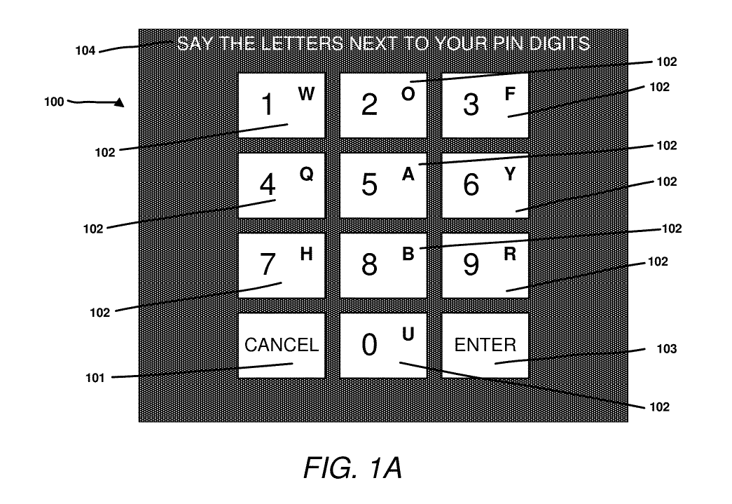

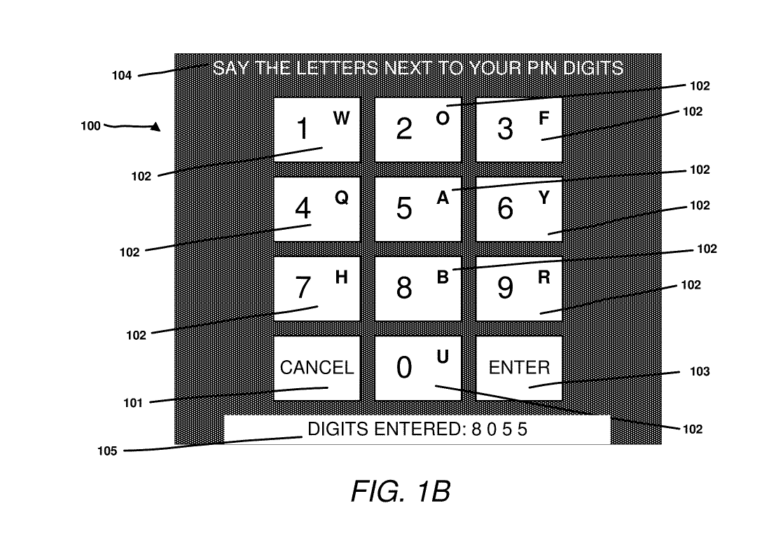

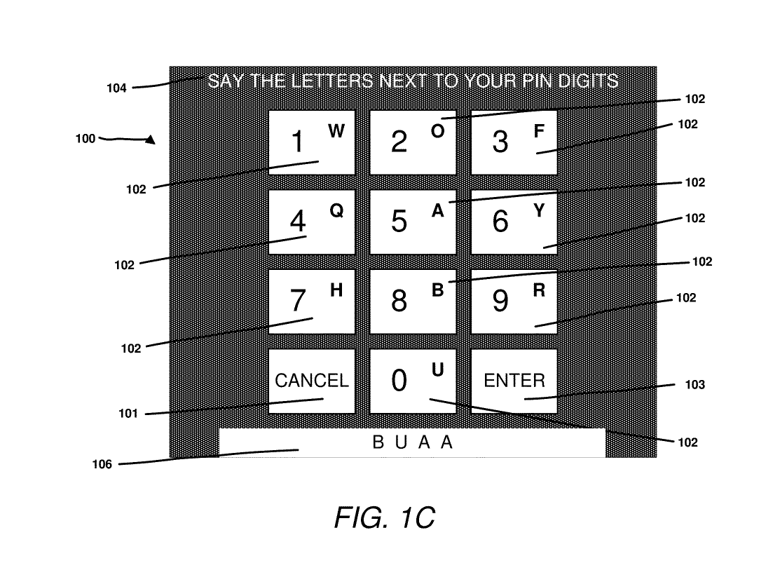

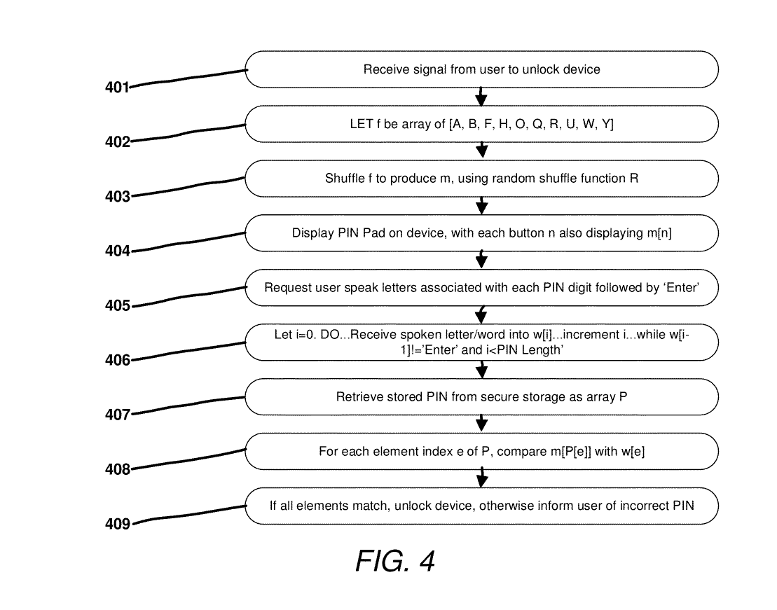

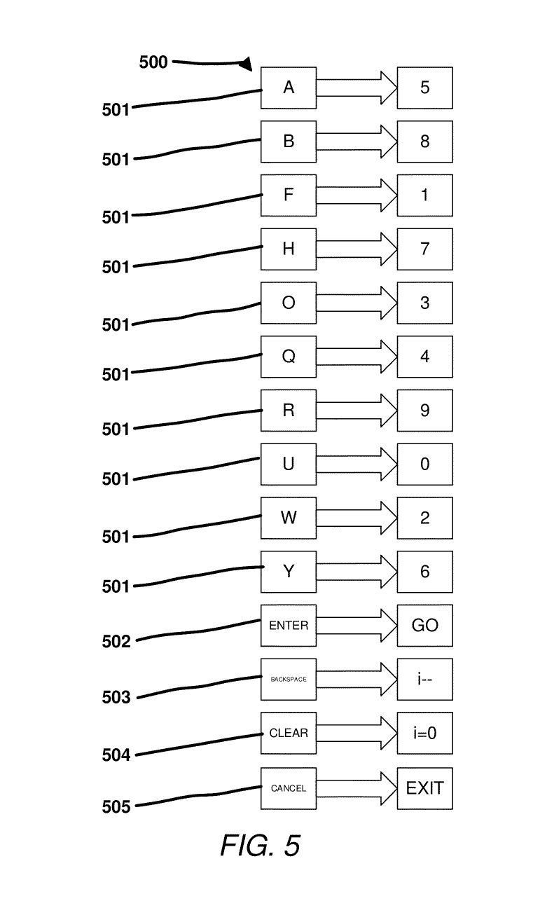

FIG. 4 is a flowchart of an example secure and hands-free process (400) for receiving user input and unlocking a computing environment. The process can be performed by, for example, the computing device shown in FIG. 3. For the purposes of illustration, FIG. 1, FIG. 3 and FIG. 5 will be used as a basis of an example to describe the process (400), but one or more other computing devices may be used to perform the process (400).

The user of the device (300) signals that she wishes to unlock functionality such as access to private data (401). She does this by touching the touch sensor (301) with a finger, tilting her head to activate head movement detection by gyroscopic and motion sensors inside the device arm, speaking a code word such as ‘unlock’ which is recorded by the device microphone and decoded with speech recognition technology or any other method that could be used to initially wake up the device from a low-power state. Alternatively, the device may be in a locked but awake state—in this case, no wake up step is required, and the display would default to showing an unlock screen such as in FIG. 1.

An array of secondary identifiers is initialized (402). This may be any set of letters, or other symbols, but in this example a particular set has been chosen because they fit the criteria of (a) sounding distinctive from each other when spoken by an English speaker and (b) have a set size of 10, equivalent to the number of possible digits normally found in one element of a PIN. To be clear, a PIN based around an octal system would have a set size of 8, and a hexadecimal system would use a set size of 16.

The distinctiveness of the sounds of each letter are to optimize performance of speech recognition technology. Letters such as M and N as normally vocalized can be more likely to be confused with each other by either manual or automatic recognition, so the choice of letters A, B, F, H, O, Q, R, U, W and Y seeks to limit such errors.

Once initialized, this array is shuffled into another array, m, using a random shuffle function R (403). Such shuffle functions are well known in the literature, described by Knuth in “The Art of Computer Programming”, and in art such as U.S. Pat. No. 5,408,448. One non-limiting example of such an R function, taken from the Wikipedia article titled “Fisher Yates Shuffle” is:

To initialize an array m of n elements to a randomly shuffled copy of f, both 0-based:

for i from 0 to n − 1 do

j ← random integer with 0 ≦ j ≦i
if j ≠ i

mi] ← m[j]

m[j] ← f[i]

It is preferred that whenever the user locks the device into a state to prevent access to private data, or after power up when the device defaults to being in the locked state, that the random shuffle function R (403) is performed before the next time the display of the PIN/letter pad (404) is shown. This shuffle function should preferably use either a hardware based Random Number Generator or introduce other known elements of randomness such as a hardware clock when generating its random integers to ensure that the shuffling is entirely unpredictable. The purpose of this is to ensure there is no predictable mapping between letters and digits displayed for any process described in this invention.

Once shuffling is complete, the device display (302) is used to present a virtual PIN pad (404). An example of such a presentation is shown in FIG. 1. The presentation (100) consists of an instruction message (104) to inform the user of how to operate the unlocking (405), a set of single digits associated with single letters (102), and functions to cancel (101) and complete (103) the unlocking of the device.

Each digit/letter pair (102) is formed from a primary identifier number n in the range of 0-9 and a corresponding secondary identifier letter taken from the shuffled array m, which for each pair is m[n]. FIG. 5 shows the example mapping (500) of each letter corresponding to the equivalent digit (501) for FIG. 1.

The digit/letter pairs (102) as shown in FIG. 1A are preferably black text on a bright white background, with the background to the rest of the display (100) in black. This contrast has been shown to make it impossible for someone other than the wearable-device (300) wearer to ascertain the associations between letters and digits. Preferably, the device display (302) has an adjustable back-light, and during the time when the lock screen (100) is visible (400) this back-light should be set to maximum intensity, so as to accentuate the white areas of the display (and thus reduce any legibility) from the non-wearer perspective. Other color combinations could also be used without altering the teachings herein—black could be replaced with a lighter grey, or contrasting colors could be used. If extra security is required, the device display (302) may also have a LCD array mounted on the outside which when activated causes the back of the display (from the wearer's perspective) to become opaque, thus preventing any view of the display by an external party. Another method of obscuring the display would be to use privacy film as sold by companies such as 3M. This could be fitted to a worn device, or even on a mobile, tablet, laptop or desktop computer to prevent eavesdroppers from seeing the mapping from letters to digits. Alternatively, other mechanical means could be used to obscure the reverse of the display to non-wearers such as a plastic clip or even the user pressing their finger against the back of the display. If such security is required, the display (302) may only be active during the functions of this invention when a signal is received such as a verbal command ‘SWITCH SCREEN ON’ passed through speech recognition systems, or a simple sensor arrangement on the external arm of the device (301) to detect the presence of a display-obscuring-finger and enable the display (302).

Once displayed to the user, the device waits to record voice input from the microphone embedded in the device frame (301). All of the possible inputs are shown in FIG. 5, and as each letter is announced by the user, it may be shown on the display (106) as in FIG. 1C or alternatively, the digit from the PIN number may be shown on the display (105) as in FIG. 1B. This digit can be determined by looking up the index of the letter as-recognized in the array m. In this case, the digit may only be briefly shown, and then replaced with an asterisk or other generic character, as is normal on PIN or password entry systems. As digits (105) are displayed, they may be shown in black text on a bright white background to again remove any chance that an eavesdropper may be able to see the digits chosen. As an alternative to displaying confirmatory letters or digits (105) on the display, the letter or digit may be in addition or only verbalized using text-to-speech and headphone circuitry in the worn device (300). Some current known wearable devices such as sold by Google Inc. use bone-conducting headphones which have the property that they are very hard to overhear, so this does not compromise security.

Also as each letter is announced by the user it is recorded, speech-recognized, then the letter output from the speech recognition is stored in array w at position i (406), with I being a zero based index to the array. So the third letter recognized, for example, would be stored in w[2]. In addition to letters recognized by the speech recognition system (501), other tokens may be recognized (502)-(505). The first token is ‘Enter’ (502), a command by the user to finish PIN entry and validate the entered PIN. If all PINs are of a fixed length, this command may not be necessary, but a variable length PIN of ‘31059’ could, for example using the mappings in FIG. 5, be successfully recognized by the user saying ‘O F U A R ENTER’. PIN codes may be of a fixed, maximum or variable length. Once a maximum or fixed length of w is achieved, the PIN code may be automatically validated (407)-(409), another alternative to the use of ‘Enter’ would be to assume after a short pause (say, 1 second) of no speech recognition that the PIN has been completed, so that validation may automatically occur.

Another command could be ‘Backspace’ (503). This would cause the last digit (105)/letter (106) recognized to be removed from the display, and the index i decremented providing a letter had been already recognized. Yet another command could be ‘Clear’ (504)—this would cause all digits (105)/letters (106) previously recognized to be removed from the display and index i reset back to zero. Whilst the example shown in FIG. 1A does not show ‘Clear’ (504) or ‘Backspace’ (503) functions, these functions could still be present and recognized by the speech recognition system without an associated display control.

A final command ‘Cancel’ would terminate the lock screen, leaving the device still in a locked state. The device could also remain in a locked state if no input is received for a certain period of time, or it is detected if that the user has removed the device from their head, or any other means such as cameras, biometrics, or Bluetooth connection to a mobile device. If an unlock process is cancelled, it's preferred that the next execution of the process should have a different, random shuffled mapping between letters and digits.

Once the array w has been filled with letters from the speech recognition system, and recognition has been completed either by ‘Enter’ command, the PIN reaching a maximum or fixed length, or a short pause being detected, the PIN may be validated.

The users' pre-stored PIN P is retrieved from storage on the device (407). Preferably, this storage is secure and not accessible to non-system applications. The pre-stored PIN is compared to a PIN derived from the letters recognized, by matching each element e of m with index P[e] with w[e] (408). So if m, as in the example in FIG. 5 is {U, F, W, O, Q, A, Y, H, B, R}, w as in the example in FIG. 1C (106) is {B, U, A, A} and P is {8, 0, 5, 5}, then

m[P[0]]=‘B’ & w[0]=‘B’

m[P[1]]=′U′ & w[1]=‘U’

m[P[2]]=′A′ & w[2]=‘A’

m[P[3]]=′A′ & w[3]=‘A’

Thus the PIN is validated and the device may be unlocked (409). If at least one of the letters do not match, or the length of P doesn't equal the length of w, then the PIN is not validated and the device should not be unlocked. Using previously known methods, in the case of non-validation the user may be given subsequent retry attempts, either up to a fixed limit, and/or with sufficient delay to deter casual attempts to ‘brute force’ or ‘dictionary’ attack PIN entry.

Alternative processes could be used to match the PIN codes without varying from the teachings of this invention. For example, a hash using an algorithm such as SHA-2 could be computed from the PIN when it is originally stored, and a second hash computed from deriving the presently entered PIN (105). If these hashes match, then the PIN is validated.

It can be seen that this process could be used to allow a user to quickly and easily change their PIN, by performing the process 3 times in succession—firstly to enter the original PIN, then secondly to enter the new PIN twice. In all three iterations the arrangement of m by random function R may be changed or kept constant if there has been no detection of removal of the worn device from the user's head.

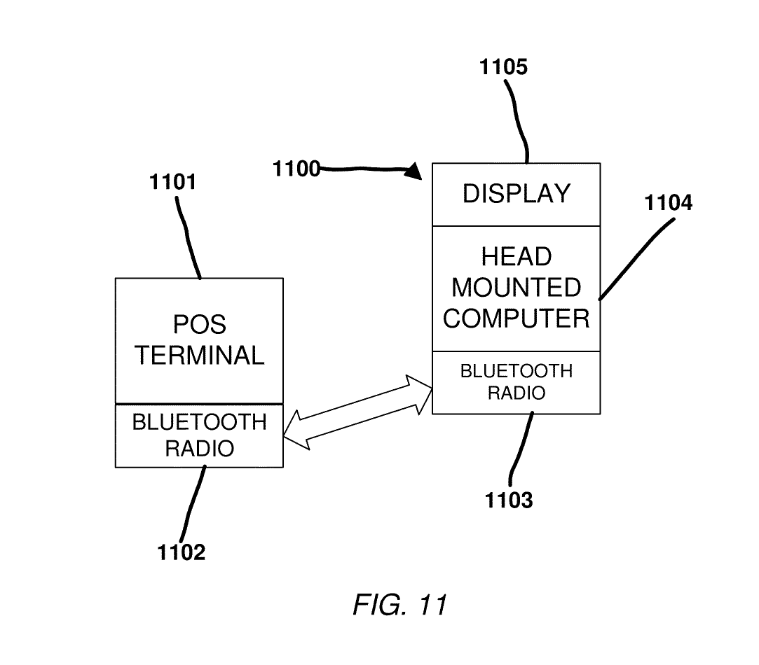

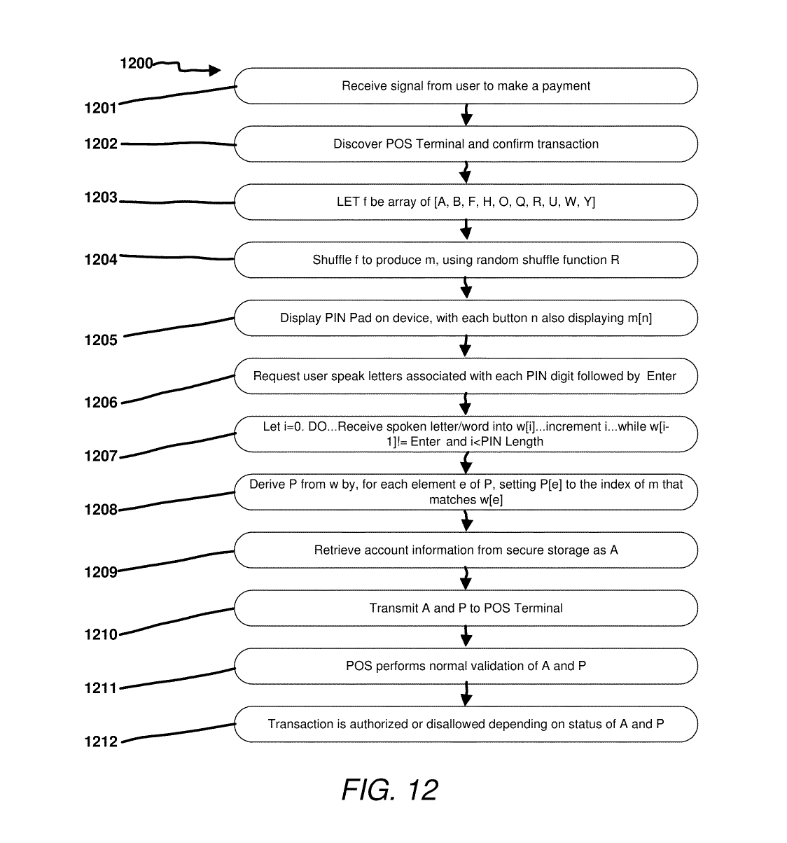

Also, the PIN may not be stored and compared on the device (408), and could for example be instead securely transmitted as a PIN or as a hash of a PIN to a second device, web service or website which could allow access to private data if the PIN is correct. This could allow the access to a banking website or application on the device without directly entering the PIN. It could also allow access to an Automatic Teller Machine (ATM), Point of Sale (POS) terminal, security system or any device where a password, security code or PIN is entered. To use the POS example, as shown overall in FIG. 11 and with an associated example process in FIG. 12, a shopper in a supermarket could wear the device (300), approach a checkout or other payment device, tap or make a voice command or otherwise enable a payment application on their worn device (1201), and the POS terminal (1101) could signal the device (300) using secure protocols such as SSL over Bluetooth (1102), WiFi or other connection technology to provide account information and security token (1202). Alternatively, the worn device (1104) may signal the POS terminal using Bluetooth (1103) or other discovery methods, or the worn device may capture a QR code, barcode or other unique identifier displayed or labelled on the POS terminal. By uniquely identifying the POS terminal, the worn device could ensure that no other checkout terminal is being incorrectly addressed. Use of Bluetooth discovery is preferred because when in low power mode (BLE) the range at which discovery can happen is sufficiently attenuated as to not allow for incorrect discovery of a further away POS terminal. Yet another non-limiting alternative would be to use an indoor positioning system (IPS) built from known technologies such as Wifi/GPS/Bluetooth to position the worn device with respect to the nearest POS terminal in the supermarket.

The worn device (300) would perform a similar process (1200) to shown in FIG. 4 (400), but would not do the final PIN comparison (407)-(409). Instead, it would securely transmit back to the terminal using the same Bluetooth technology pre-stored account information along with the PIN derived from the voice entry (1210)—P, where each element of P is formed from the index into m of the occurrence of the corresponding element of w found in m (1208). So, as a non-limiting example, if w was {B, U, A, A} (106), and m was is {U, F, W, O, Q, A, Y, H, B, R}, then w′ would be {8, 0, 5, 5} given that B is the 8^{th} element of m, U is the 0^{th} element of m, and A is the 5^{th} element of m, using a zero based index system. Once received by the terminal, the account information and PIN would be used by existing banking infrastructure (1211) to authenticate the transaction (1212). It is a clear advantage of this invention over existing technologies such as ‘chip and PIN’ or ‘tap and pay’ that this transaction would not allow another person present to see or otherwise snoop the PIN or other secret code.

Whilst this non-limiting POS example does not require a physical magnetic strip or smart card as currently used by most payment technologies, such existing cards could also be used: the shopper would insert their magnetic strip or smartcard into the POS terminal, which would signal the device (300) as above using preferably a secure Bluetooth connection. Existing NFC enabled smart phones, tablets or other mobile devices could also be used—by tapping the phone against the ‘tap n go’ terminal, the signal would be generated to be sent to the worn device over secure bluetooth (1201) along with the POS terminal identification obtained via the NFC link between the phone and POS terminal. This would allow the worn device to be woken from sleep state to directly communicate with the POS terminal over Bluetooth or other radio link. Alternatively, all communication between the worn device and the POS terminal could be proxied via the phone over NFC link to use existing infrastructure without any need to install Bluetooth at the POS terminal. The worn and/or mobile device would follow the process (1200) to obtain a derived PIN in P, which would be transmitted to the POS terminal (1210). The account information would remain at the smartcard/POS terminal and need not be stored or accessed on the device (300). This would allow account information to be securely stored within the smartcard, accessed by the POS terminal using normal secure methods such as EMV, using as a security token a PIN securely input by the worn device (300) and transferred to the POS terminal.

It should also be clear that this, and other processes in this disclosure, contemplate the secure entry of passwords, passphrases or other secrets as well as PINs. In general, a display of a first set of letters or symbols alongside a matching random arrangement of other symbols, which could be from the same set of letters or symbols, displayed on a device such as that shown in FIG. 3 would allow for secure entry of a secret by the user performing the substitution of each letter or symbol entered with its associated randomly chosen paired letter or symbol.

For any implementation that follows the teachings of this invention it can be seen that it is impossible for an eavesdropping party to discern the PIN by listening to the letters spoken, since the mapping of letters to digits changes on every execution of the unlock process.

Furthermore, an additional level of security may be obtained by changing the mapping function m (403) after each secondary identifier (such as an individual letter) is input (406). The display (102) would also be updated to reflect the new mapping between numbers and letters. This additional level of security would prevent an eavesdropper from even ascertaining that a set of primary identifiers (such as a PIN) had two or more elements that were the same. For example, as m would change between each letter input even a simple PIN such as {0, 0, 0, 0} could be input as four distinct letters. This additional level of security could be used with all of the methods described in this invention.

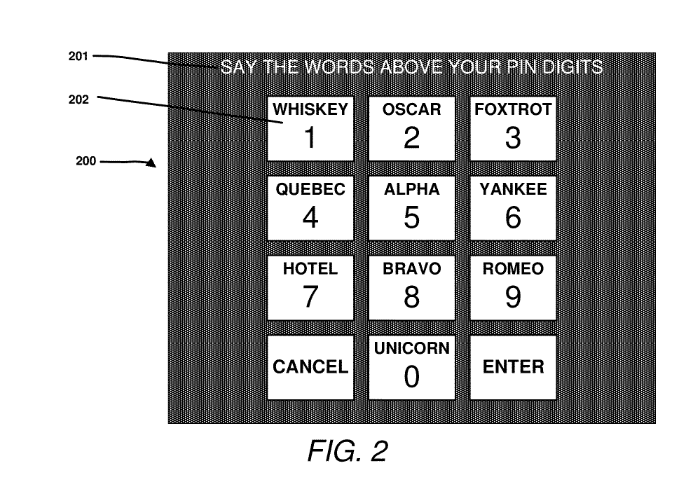

FIG. 2 shows how this process may be adapted to use words rather than letters for the secure input of a PIN and shows that this invention could be readily adapted to use other sets of words, numbers or other symbols, and is not limited to letters. In this example (200), each digit has been associated with a word from the English phonetic alphabet. The phonetic alphabet is chosen because it has the property that each word sounds distinct from the others. Each word (202) is spoken in place of the letter (102) from FIG. 1A, and the instruction on the display (201) is changed accordingly. As another alternative, the display from FIG. 1A may be used, but the speech recognition system may automatically convert phonetic alphabet words into their letter equivalent. So if the user said ‘Quebec’, the letter ‘Q’ would be placed in the current letter array w, at position i (406). This would allow users to interchange between letters and phonetic alphabet words without making a prior configuration change.

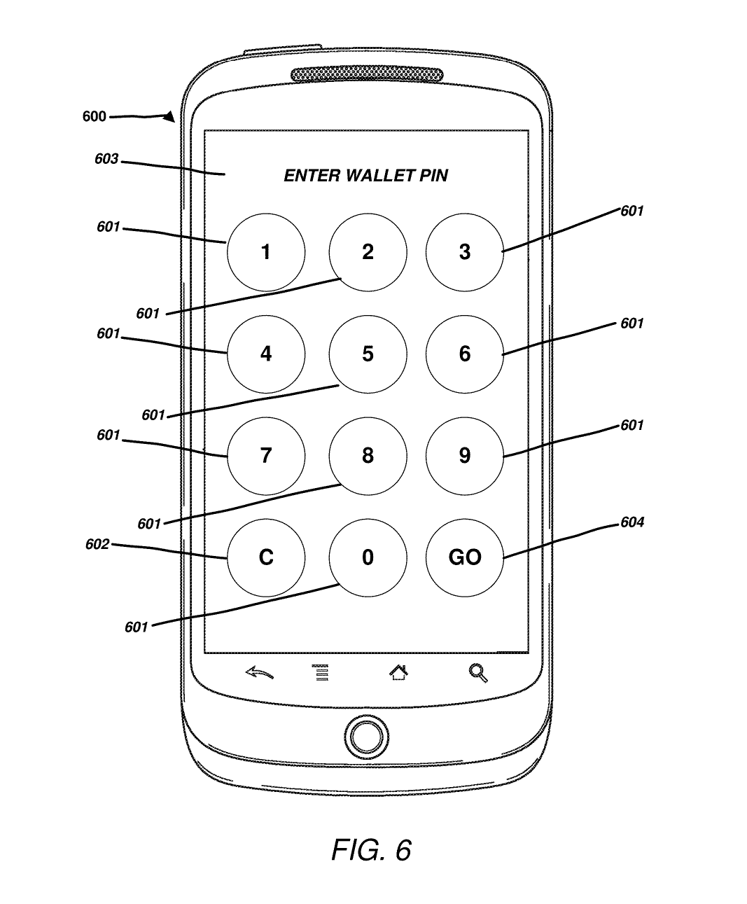

FIG. 6 shows a typical mobile device (600) commonly known as a smartphone. Smartphones are commonly used to store personal data, and as such usually offer locking methods such as PIN entry (601) or gesture drawing as disclosed in U.S. Pat. No. 8,504,842. These methods suffer the same issue as wearable devices in that another person may snoop and watch the PIN or gesture being entered, and use this information after obtaining the device, or even in other applications as it is very common for users to re-use their PINs across other devices or accounts.

Smartphones, in addition to using PINs/passwords for locking any access to the phone, also use PINs or passwords within applications such as e-wallets (603), or access to secure banking websites or applications.

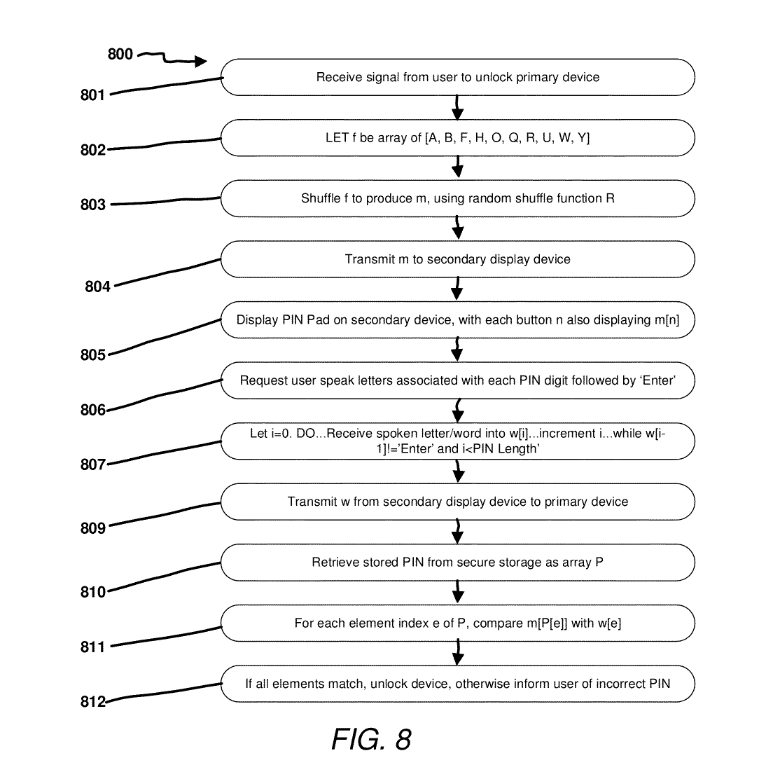

FIG. 8 shows a non-limiting process (800) for the use of a secondary device, which is preferably a wearable device (300), to securely unlock or access private data in place of a PIN being entered directly on a primary device (600) such as shown in FIG. 6. This process (800) could also be used for other primary devices such as laptops, desktop PCs running such operating systems such as Windows or MacOS or indeed any device where a user is required to enter a PIN, password or security code that is at risk of being watched by another unauthorized party.

The user of the primary device signals that they wish to unlock the secure data or functionality held on it (801). The user does this by known methods such as pressing the power button, using a voice command to wake the device, or by other methods including, but not limited to, starting an application, or selecting a secured function of an application, website or other functionality.

As in the process shown in FIG. 4 (402), an array of letters is initialized (802) using the same rationale described above. Also as in the FIG. 4 process (403), these letters are shuffled (803) to produce array m, again as described above.

Initialization (802) and shuffling (803) preferably takes place on the primary device, though it could also be performed by the secondary device, or even a third device or server such as a cloud-based computing system.

In the preferred implementation, m is then transferred to the secondary device (804). The method used to transfer this information is preferably by Bluetooth radio, though WiFi, 3G/4G/LTE or other network connection methods could be used. Non-network methods such as physical connections over USB cables could also be used. It is preferred that the protocol used to transfer m be encrypted with a known secure method such as SSL, HTTPS or VPN. This prevents the Bluetooth or other connection being itself eavesdropped.

The use of Bluetooth is preferred because of its low power profile. The secondary device can remain in a semi-powered down state awaiting an incoming Bluetooth data connection. Once m is transferred to the secondary device, or generated at it, it is used to generate the PIN/letter pad (805) which is displayed as before on the secondary device (100). Preferably, rendering this display (100) also causes the secondary device LCD screen to be activated, as the normal state may be for the wearable device to have its screen de-activated to conserve battery power. This also obviates the need for the user to activate the secondary device from its low power state by a head-tilt, button press or other activation method.

Again, as in the process shown in FIG. 4 (405), the user is requested to speak the letter associated with each digit of their PIN followed by the word ‘Enter’ (806). Speech recognition technology is used to capture these inputs (807) and translate them into letters stored in array w (807) as described above with reference to FIG. 4 (406).

In this preferred example of the process (800), w is then securely transmitted back to the primary device (809), again preferably using the same transfer method as before (804). The primary device can then retrieve the stored PIN from secure storage (810) and compare it, as described above (408), with the received data. Again, as described above, the derived PIN, password or other secret may not be present in local storage and instead be passed to a third server over an internet or other network connection to provide authentication for an application or website or other device such as a POS terminal, ATM or security system.

If m were to be generated from f on the secondary device, m could also be transmitted, or the derived PIN P (1208) could instead be transmitted as described above with reference to FIG. 12.

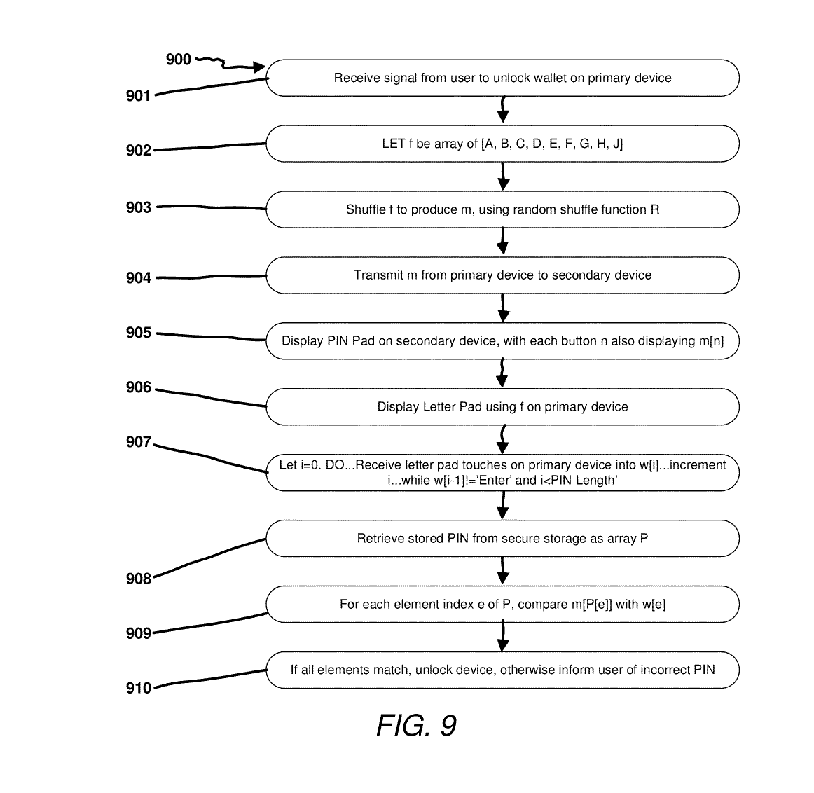

FIG. 9 is an example of another process that implements the teachings of this invention. This process is suitable for users that cannot or do not wish to use speech recognition. In this example (900) it is used to unlock a wallet on a primary device on a mobile phone, but as has been shown above and should be readily apparent, this process could also be used to unlock a smartphone or other computing device, unlock a worn device, transmit a PIN, password or other secret to a POS terminal or security system, log into a website or any other application which requires the input of a secret.

The process is initiated by a user signal (901) such as opening a wallet application on the primary or worn device, tapping a NFC enabled primary device against a NFC reader attached to a POS terminal or any other way of signaling that the wallet needs to be accessed. As opposed to other processes (802), this process preferably uses a simple set of symbols labeled ‘f’ (902) such as the first 10 letters of the alphabet (with the letter ‘I’ removed to prevent any confusion with the number 1).

As described before, f is shuffled by function R (903) to produce m. The generation and shuffling of f could take place on the primary device, worn device, on a server or any computing device. In this example, f is generated and shuffled on the primary device and transmitted to the secondary (worn) device (904). Of course, the secondary device may not necessarily be worn, and could be any device with a display. It is envisaged that the secondary device would be in a low power mode, with display disabled until it receives a signal such as the transmission of f over a secure Bluetooth or other radio link, at which point the display would be switched on for display of a PIN pad.

As before, the PIN pad (705) is shown with associated letters (706) on the secondary device (905) along with an instruction to enter letters on the primary device (704). However, at this point, in addition to, or as an alternative to allowing voice input of the letters, a letter pad (700) is shown on the primary device (906). This letter pad consists of the array of letters from f (701) along with controls to cancel the entry of a letter (702) and confirm the PIN entry (703).

Touches are now received (907) via a touchscreen device associated with the display on the primary device (700) to match the letters associated with digits shown on the secondary display (705). These are stored in array w, as described above (406) with reference to FIG. 4. If speech recognition is enabled, voice input of letters can also populate w at this stage.

The process shown in FIG. 9 then proceeds as the same as the process shown in FIG. 4; the stored PIN is compared against a PIN derived from the letters input, either by forward mapping the stored PIN using m or reverse mapping w into a derived PIN. If the PINs match, the device, application or function is unlocked and access is granted.

As noted above, this process (900) could be used to unlock the secondary device, or even both the secondary device and primary device at once; in these cases the original signal (901) may be generated at either the primary or secondary device, by a non-limiting example of tapping the touch pad or tilting the head, and passed to the primary or secondary device (900) over the secure Bluetooth radio link, to cause the rest of the process to proceed. Similarly, this process may be adapted to enhance the earlier described process (1200) to also allow for touch input at the primary device, or even at the POS terminal or other electronic device of letters or other symbols by a physical keypad or touchscreen rather than by voice input. It can also be seen how this process may readily adapt for passwords or other secure input types by providing the ability for a user to map secrets into strings of symbols that do not reveal the secret to an eavesdropper or listener.

All of the above processes need not depend on worn displays. A non-limiting example of an alternative would be for a car to be equipped with a dashboard-mounted display and Bluetooth radio. If a driver approached a drive-thru ATM, the dashboard-mounted display could act as the secondary or worn display for any of the above processes. This would prevent ‘skimming’ occurring at the ATM because no direct PIN entry would occur. As a cheaper implementation of this example, the worn device may simply be a small keyfob sized display with Bluetooth radio, but no other input required, which could be held somewhat covertly within the palm and used to map a PIN into a set of letters or other numbers for input into a primary device, ATM, POS terminal or other electronic device.

It should be apparent that this invention would also work well with teachings such as US Patent Application Publication 20130282502, assigned to Google Inc., which uses a hybrid wallet approach with proxy account information to allow users of NFC enabled payment systems to select different accounts for different transactions; this invention handles the security of access to the wallet, and relies on the existing application to handle account management.

Another process that could be used to enter secure data at the secondary or even primary device would be gaze detection using technologies developed by companies such as Tobii or Eyetribe. These technologies require cameras or other sensors aligned such that they can determine the gaze of the user by following the movement of the user's pupil. As an example, in this invention, the PIN Pad could be displayed on the worn display, which would be private to the user as described above. The user would look at each PIN digit in turn (102), and after a suitable period of gazing at a digit (say 1 second), the gaze determination algorithms would determine the looked at number and display it (105) to the user or communicate it using text-to-speech over the worn device headphone or other audio output. If a ‘Cancel’ (101) was gazed at for a period of time, then the last digit entered would be deleted, and if Enter (103) was gazed at, PIN entry would be completed for validation.

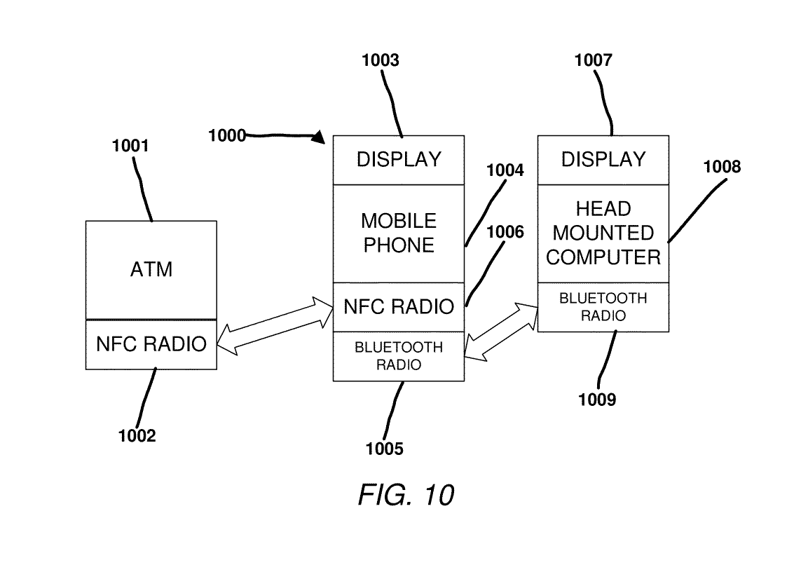

FIG. 10 is a non-limiting example (1000) of a system providing for the interaction with an ATM (1001) equipped with Near Field Communication (NFC) capabilities (1002), a NFC (1006) equipped mobile phone (600)(1004) and a wearable computer (300)(1008). This example could also apply to POS terminals, security systems or anywhere PINs or passwords need to be entered. In particular, this example leverages existing EMV/NFC infrastructure such as ‘tap and pay’. It should be clear that, as in all facets of this invention, other competing near-distance communication technologies could also be used such as Bluetooth Low Energy (BLE) or ultrasonic audio without varying from the teachings of this disclosure.

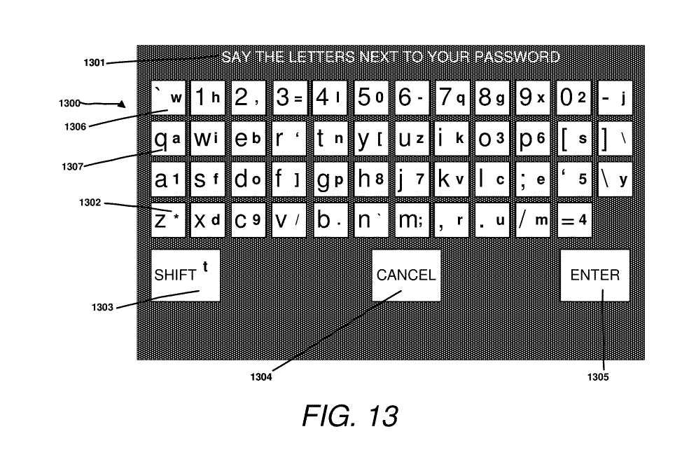

Throughout this disclosure it has been described that the taught methods of this invention also apply to passwords, or any type of entered secret such as a Social Security Number as well as PIN codes. FIG. 13 shows a non-limiting example arrangement of a password entry display for a worn, secondary or other device which maps letters, numbers and symbols to other letters, numbers and symbols as taught throughout this disclosure. In this example display (1300), a message informing the user to speak letters or symbols (1302) is used. The letters, numbers and symbols have been randomly shuffled with function R as before and displayed with their associated possible password letter (1307), symbol (1306) or number. In addition there is a shift function (1303) which is used to access other symbols such as exclamation or hash marks, or to change case of the letters entered. Preferably, using the shift key does not change the letter entered, only the case, so if the user wishes to enter a Q (1307), they would say ‘T’ (for shift) followed by ‘A’. Saying the shift value (1303) of ‘T’ may preferably cause the displayed possible password values to change but only the letters to uppercase for the letters to be spoken. Another feature of this arrangement is that it is impossible for an eavesdropper to ascertain that ‘t’ is in fact shift, so it is not possible to determine which characters of the password are uppercase or symbols. The set of symbols/letters used for vocalization need not be the same as present on a keyboard—in this example the letter ‘z’ maps to an asterisk symbol, which is normally a ‘shift-8’ on a keyboard. Also, as before, words may be spoke instead of letters, symbols or numbers, or even multiple symbols or digits. So, as a non-limiting example, the number ‘812’ may map to the letter b. This would mean that the user could enter their password as a long string of digits which would make it easier for the speech recognition system to not make mistakes. This approach also lends itself well to non-alphabetical languages such as Japanese or Mandarin, where a large number of symbols may need to be mapped.

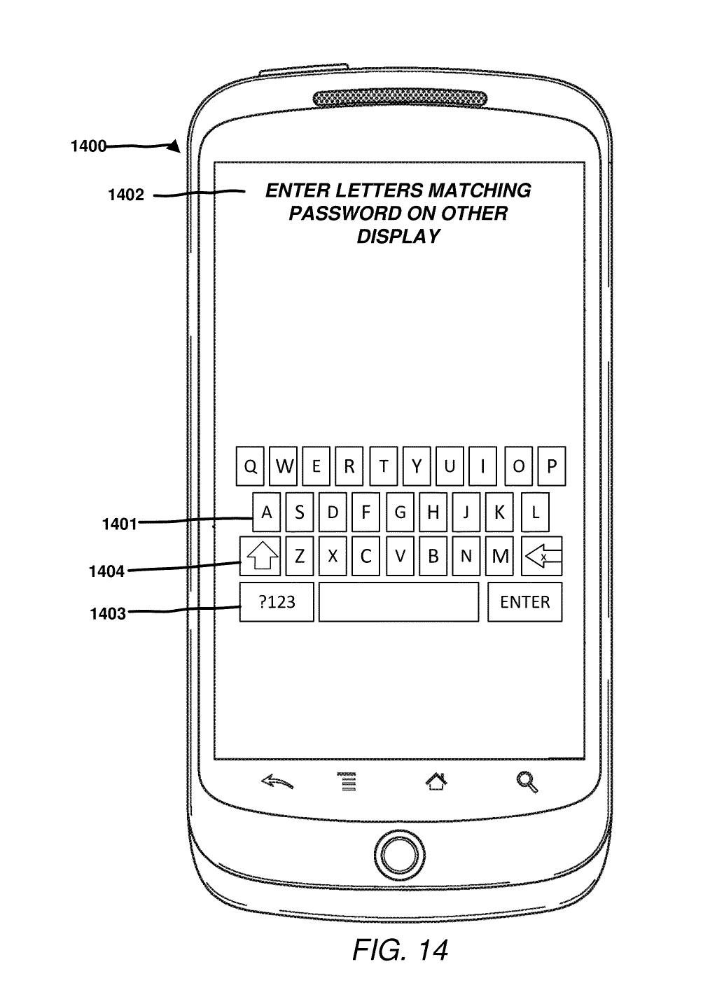

FIG. 14 shows how the teachings of the example process shown in FIG. 9 may be used for password entry. In this case, as before, voice control is optional, and the user is instructed to enter (1402) letters or symbols (1401) on a virtual keyboard on the primary device (1400). The user, as they enter their matching letters or symbols from the secondary device display, can use the shift key (1404), or “?123” (1403) or other functions to access extra symbols for entry. If a multidigit-to-letter approach is used (the ‘812’ to ‘b’ example above) then only a normal PIN pad as in FIG. 6 may be required.

What is claimed is:

1. A system for entering a secret into an electronic device comprising:
A display configured such that it is only viewable by a single user;
Translation information displayed on the display comprising of:
a) A plurality of primary identifiers;
b) A plurality of secondary identifiers, where each secondary identifier is associated with exactly one corresponding primary identifier;
Where the secondary identifiers are associated with their corresponding primary identifier by a mapping function;
An input method comprising of:
a) Receiving one or more inputs indicating a secondary identifier from a user;
b) Mapping each input secondary identifier using the mapping function to its corresponding primary identifier to generate one or more primary identifiers;
c) Using the one or more primary identifiers as an input to an authentication function;
Where the authentication function allows access to private data or functionality associated with an electronic device.

2. The system of claim 1, wherein the primary identifiers are numeric and the secondary identifiers are alphabetic.

3. The system of claim 2, wherein the mapping function further comprises of:
a) Establishing an alphabetic ordering of the secondary identifiers;
b) Randomly shuffling the ordering of the secondary identifiers.

4. The system of claim 3, wherein the input method receives one or more inputs indicating a secondary identifier by a speech recognition mechanism.

5. The system of claim 3, wherein the authentication function uses a hash algorithm to create a hash value to match against a previously stored hash value.

6. The system of claim 5 where the hash algorithm is SHA-2.

7. The system of claim 3, wherein the authentication function matches its input against a previously stored one or more primary identifiers.

8. The system of claim 1, wherein the private data or functionality is stored on the first electronic device.

9. The system of claim 1, wherein the private data or functionality is stored on a second electronic device.

10. A system for entering a secret into an electronic device comprising:
A first display configured such that it is only viewable by a single user;
Translation information displayed on the first display comprising of:
a) A plurality of primary identifiers;
b) A plurality of secondary identifiers, where each secondary identifier is associated with exactly one corresponding primary identifier;
Where the secondary identifiers are associated with their corresponding primary identifier by a mapping function;
A second display configured to display the plurality of secondary identifiers;
Input controls associated with the second display, where each control is associated with a secondary identifier;
An input method comprising of:
a) Receiving one or more inputs associated with the second display indicating a secondary identifier from a user;
b) Mapping each input secondary identifier using the mapping function to its corresponding primary identifier to generate one or more primary identifiers;
c) Using the one or more primary identifiers as an input to an authentication function;
Where the authentication function allows access to private data or functionality associated with an electronic device.

11. The system of claim 10, wherein the primary identifiers are numeric and the secondary identifiers are alphabetic.

12. The system of claim 11, wherein the mapping function further comprises of:
a) Establishing an alphabetic ordering of the secondary identifiers;
b) Randomly shuffling the ordering of the secondary identifiers.

13. The system of claim 12, wherein the input method receives one or more inputs indicating a secondary identifier by a touchscreen device.

14. The system of claim 11, wherein the authentication function uses a hash algorithm to create a hash value to match against a previously stored hash value.

15. The system of claim 14 where the hash algorithm is SHA-2.

16. The system of claim 11, wherein the authentication function matches its input against a previously stored one or more primary identifiers.

17. The system of claim 10, wherein the private data or functionality is stored on the first electronic device.

18. The system of claim 10, wherein the private data or functionality is stored on a second electronic device.

19. A method for entering a secret into an electronic device comprising:
Establishing a plurality of primary identifiers, and a plurality of secondary identifiers, where the number of primary identifiers is identical to the number of secondary identifiers;
Associating each secondary identifier with a corresponding primary identifier by use of a mapping function;
Displaying on a display configured such that it is only viewable by a single user translation information comprising of:
a) The plurality of primary identifiers;
b) The plurality of secondary identifiers, where each secondary identifier is associated with exactly one corresponding primary identifier;
Processing input from a user comprising of:
a) Receiving one or more inputs indicating a secondary identifier from a user;
b) Translating each input secondary identifier using the mapping function to its corresponding primary identifier to generate one or more primary identifiers;
c) Using the one or more primary identifiers as an input to an authentication function;
Where the authentication function allows access to private data or functionality associated with an electronic device.

20. A method for entering a secret into an electronic device comprising:
Establishing a plurality of primary identifiers, and a plurality of secondary identifiers, where the number of primary identifiers is identical to the number of secondary identifiers;
Associating each secondary identifier with a corresponding primary identifier by use of a mapping function;
Displaying on a first display configured such that it is only viewable by a single user translation information comprising of:
a) The plurality of primary identifiers;
b) The plurality of secondary identifiers, where each secondary identifier is associated with exactly one corresponding primary identifier;
Displaying on a second display the plurality of secondary identifiers;
Processing input from a user at an input device associated with the second display comprising of:
a) Receiving one or more inputs indicating a secondary identifier from a user;
b) Translating each input secondary identifier using the mapping function to its corresponding primary identifier to generate one or more primary identifiers;
c) Using the one or more primary identifiers as an input to an authentication function;
Where the authentication function allows access to private data or functionality associated with an electronic device.
